(19) United States
(12) Patent Application Publication
(10) Pub. No.: US 2005/0254926 A1
(43) Pub. Date: Nov. 17, 2005

(54) Portable vehicle lift and work station and method therefor

(76) Inventor: Daniel Howison, Tempe, AZ (US)

Correspondence Address: WEISS & MOY PC, 4204 NORTH BROWN AVENUE, SCOTTSDALE, AZ, 85251, US

(21) Appl. No.: 10/847,126

(22) Filed: May 17, 2004

(51) Int. Cl. B66F 7/10

(52) U.S. Cl. 414/495

(57) ABSTRACT

A portable mechanics lift has a platform. A pair of wheel channels are coupled to the platform. The wheel channels are used for allowing a vehicle to drive onto the platform. A vehicle lift is coupled to the platform. The vehicle lift is used for raising and lowering the vehicle. A plurality of wheels are rotatably coupled to the platform for moving the portable mechanics lift.

### BACKGROUND OF THE INVENTION

1. Field of the Invention

This invention relates to a automotive repair and, more specifically, to a portable vehicle lift and work station which will allow a mechanic to drive to any location and service the vehicle.

2. Description of the Prior Art

When a vehicle needs to be serviced, the vehicle is generally taken to a mechanic. While a mechanic can perform routine maintenance without having to raise the vehicle, most mechanics generally place the vehicle on a vehicle lift to raise the vehicle off the ground. By raising the vehicle, the mechanic is better able to reach different areas underneath the vehicle to more easily service the vehicle.

Servicing a vehicle is especially problematic when the vehicle breaks down. In this situation, one must have the vehicle towed to a service shop in order to diagnose and fix the vehicle. Once the vehicle arrives at the service shop, the vehicle again has to be placed on the vehicle lift in order for the mechanic to service the vehicle.

For many people, it would be easier and more convenient to have their car serviced at their residence, workplace, or some place which was not out of the way and is more convenient than a vehicle repair center. Unfortunately, most mechanics require the use of a vehicle lift to service a vehicle. Presently, there are no vehicle lifts which are portable. Thus, mechanics are unable to perform most services on a vehicle at a location other than at the vehicle repair shop. Several patents have been written on different types of portable automotive jacks. However, automotive jacks are used more for lifting a side of a vehicle to change a tire. Automotive jacks are not able to lift the entire vehicle off the ground in order to service the vehicle.

Therefor, a need existed to provide a portable vehicle lift. The portable vehicle lift will over come the problems associated with prior art mechanisms. The portable vehicle lift may be driven to any location and allow a mechanic to raise a vehicle in order to service/repair the vehicle.

### SUMMARY OF THE INVENTION

In accordance with one embodiment of the present invention, it is an object of the present invention to provide a portable vehicle lift.

It is another object of the present invention to provide a portable vehicle lift that will over come the problems associated with prior art mechanisms.

It is still another object of the present invention to provide a portable vehicle lift which may be driven to any location to allow a mechanic to raise a vehicle in order to service/repair the vehicle.

### BRIEF DESCRIPTION OF THE EMBODIMENTS

In accordance with one embodiment of the present invention a portable mechanics lift is disclosed. The portable mechanics lift has a platform. A pair of wheel channels are coupled to the platform. The wheel channels are used for allowing a vehicle to drive onto the platform. A vehicle lift is coupled to the platform. The vehicle lift is used for raising and lowering the vehicle. A plurality of wheels are rotatably coupled to the platform for moving the portable mechanics lift.

The foregoing and other objects, features, and advantages of the invention will be apparent from the following, more particular, description of the preferred embodiments of the invention, as illustrated in the accompanying drawing.

### BRIEF DESCRIPTION OF THE DRAWINGS

The novel features believed characteristic of the invention are set forth in the appended claims. The invention itself, as well as a preferred mode of use, and advantages thereof, will best be understood by reference to the following detailed description of illustrated embodiments when read in conjunction with the accompanying drawings.

FIG. 1 is a side view of the portable vehicle lift of the present invention with the lift mechanism in a lowered position.

FIG. 1A is a side view of the vehicle lift of the present invention with the lift mechanism in a raised position.

FIG. 2 is a top view of the portable vehicle lift of the present invention with the lift mechanism in a lowered position.

FIG. 2A is a top view of the vehicle lift of the present invention with the lift mechanism in a raised position and the support legs in a down position.

### DETAILED DESCRIPTION OF THE PREFERRED EMBODIMENT

Referring to the Figures, a portable vehicle lift 10 (hereinafter vehicle lift 10) is shown. The vehicle lift 10 may be drive to any location where a vehicle needs to be serviced. The vehicle lift 10 allows one to raise a vehicle in the air in order to better and more easily service the vehicle. Thus, the vehicle lift does not require a person to have the vehicle taken to the vehicle repair center for service.

The vehicle lift 10 has a platform 12. The platform 12 forms the foundation of the vehicle lift 10. The platform 12 further allows a person to walk on the vehicle lift 10 when a vehicle is lifted. Thus, a mechanic can walk on top of the platform 12 to service a vehicle when a vehicle is positioned on the vehicle lift 10 and raised in the air. The platform 12 is generally made of a lightweight but sturdy metallic material. The platform 12 is generally a long rectangular metal platform. However, the size and shape of the platform may vary and should not be seen as to limit the scope of the invention.

On each side of a top surface of the platform 12 is a wheel channel 14. The wheel channel 14 are used to guide a vehicle on to the top surface of the platform 12. The wheel channels 14 keep the tires of the vehicle straight thereby properly aligning the vehicle on the vehicle lift 10. The wheel channels 14 also prevent the vehicle from driving off of the platform 12. The wheel channel 14 is generally comprised of a “U” shaped metal channel. The “U” shaped channel is sized so that the width of the tire fits within the “U” shaped channel. The edges of the “U” shaped channel keeps the tire straight and prevents the tire from turning. The wheel channel 14 is generally made out of a light weight metal material. A metal mesh may be used. The metal mesh will allow the tires of the vehicle to have better traction thereby preventing the wheels of the vehicle from spinning out.

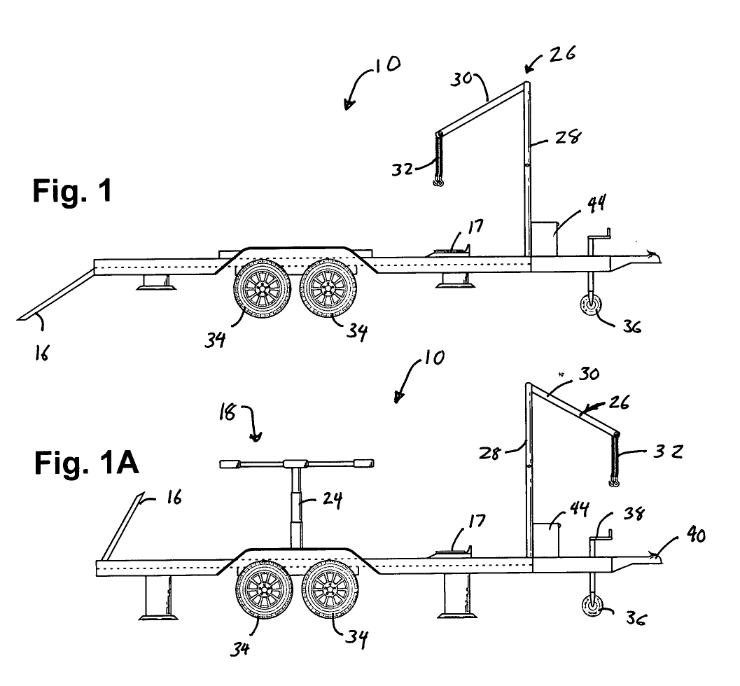

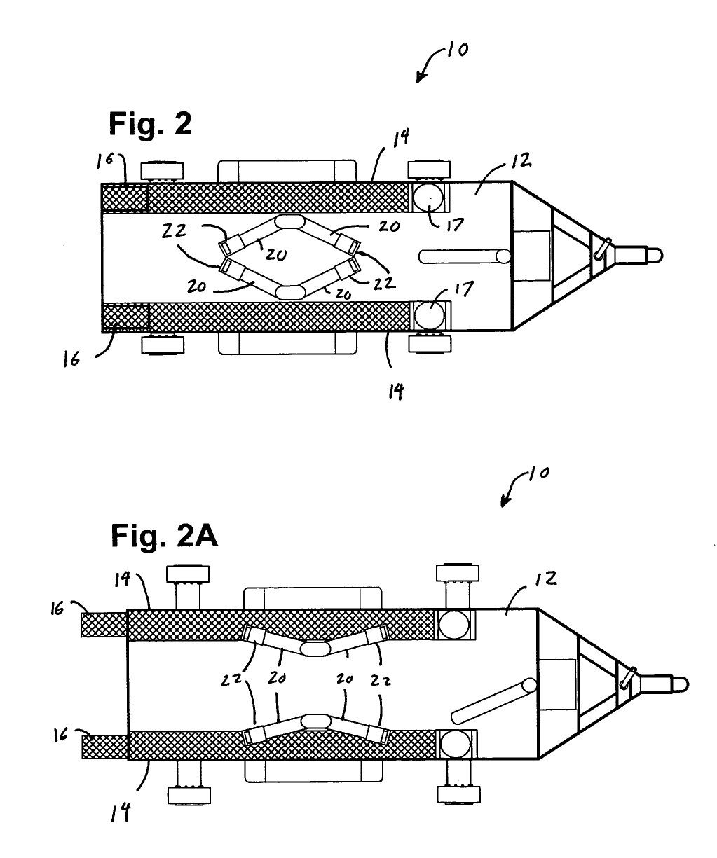

At a lower end of each wheel channel 14 is a hinged ramp 16. Each ramp 16 is foldably coupled to an individual wheel channel 14. The ramps 16 are used for two different purposes. First, when the ramps 16 are lowered (FIG. 1), the ramps 16 allows a vehicle to be driven up the ramps 16 and onto the wheel channels 14. Thus, the ramps 16 are used to allow a vehicle to be driven onto the top of the platform 12. The ramps 16 may further be folded in an upright position as shown more clearly in FIG. 1A. In the folded position, the ramps 16 are used to hold a vehicle in place and to prevent the vehicle from moving. Thus, in the folded position, the ramps 16 function in a similar manner as chocks. The ramps 16 are generally made out of the same material as the wheel channels 14. However, this should not be seen as to limit the scope of the present invention.

At the top end of each wheel channel 14 is a front end alignment stand 17. When a vehicle is properly positioned on the platform 12, the front wheels of the vehicle will be positioned on the alignment stands 17. Once the tires are positioned on the alignment stands 17, a mechanic can make sure the wheels are parallel, the steering wheel is centered and the vehicle is set straight. Thus, the alignment stands 17 allow a mechanic to perform front end alignments on the vehicle. The alignment stands 17 are generally coupled to a computer to allow the mechanic to perform computerized alignment of the wheels. Clips are coupled to each wheel front and rear so that the computer can analyze the alignment of all the wheels of the vehicle.

A vehicle lift 18 is coupled to a center area of the platform 12. The vehicle lift 18 is used to raise and lower a vehicle which is properly parked on the platform 12. The vehicle lift 18 has a plurality of moveable arm members 20. The arm members 20 are able to move in a horizontal plane. This will allow one to better position the arm members 20 underneath the vehicle so that the vehicle lift 18 may be able to safely raise the vehicle. The arm members 20 are generally made out of a heavy duty metal. However, other materials may be used with out departing from the spirit and scope of the present invention.

At an end of each moveable arms 20 is a holding member 22. When the arm members 20 are properly positioned underneath the vehicle, the holding member 22 will be positioned on a load bearing section of the vehicle. The holding member 22 will prevent the load bearing section from moving thus securing the vehicle to the arm member 20. In accordance with one embodiment of the present invention, the holding member 22 has a channeling. The load bearing section of the vehicle is generally positioned in the channeling. The channeling prevents the load bearing section from moving. The holding member 22 may further be a “C” shaped device or the like. The listing of the above holding members should not be seen as to limit the scope of the present invention. The holding members 22 are generally made out of the same material as the arm members 20. However other materials may be used without departing from the spirit and scope of the present invention.

A telescoping pole 24 is coupled to the moveable arms 20. The telescoping pole 24 is used to raise and lower the moveable arms 20. The telescoping pole 24 is comprised of a plurality of sections which are positioned internal to one another. A metal material is generally used to make the plurality of sections. By raising and lowering different sections, one may raise or lower the telescoping pole 24. One or more telescoping poles 24 may be used to raise and lower the vehicle lift 18.

The telescoping pole 24 is generally raised or lowered using hydraulic means. Hydraulic means generally work by using an incompressible fluid. Force that is applied at one point is transmitted to another point using the incompressible fluid thereby raising and lowering the telescoping pole 24. However, other means of raising and lowering the telescoping pole 24 may be used. For example, mechanical, electrical, manual, etc. means may be used. The listing of the above should not be seen as to limit the scope of the present invention.

At a front area of the platform 12 is a lift 26. The lift 26 is generally a swing arm lift which may be used to raise and lower an engine block or other heavy items. The lift 26 may be a hydraulic lift, an electrical lift, a mechanical lift, a manual lift, or the like. The lift 26 is generally comprised of a support stand 28 which is rotatably coupled to the platform 12. By having a rotating support stand 28, one may rotate the lift 26 to move heavy objects to and from a vehicle. An arm 30 is moveably coupled to the support stand 28. The arm 30 may be moved in an up and down manner to raise and lower an object. An attachment device 32 is coupled to the arm 30. The attachment device 32 allows one to attach different objects to the lift 26 so that the objects may be moved.

In order to move the vehicle lift 10, wheels 34 are rotatably coupled to the platform 12. The wheels 34 allow the vehicle lift 10 to be moved to any location. In general two pairs of wheels 34 will be used. Each pair of wheels 34 are generally rotatably coupled to the platform using an axle assembly. Since axle assemblies are well known in the art, further description of the axle assembly will not given.

Another wheel 36 is rotatably coupled to a front area of the platform 12. The wheel 36 is used more for guiding the vehicle lift and for aligning the vehicle lift 10 with a truck for towing the vehicle lift 10 to a desired location. The wheel 36 is coupled to a crank arm 38. The crank arm 38 allows one to turn the direction of the wheel 36 by rotating the crank arm 38. By turning the crank arm 38, one can align the wheel 36 in the direction one wants the vehicle lift 10 to travel. It should be noted that once the vehicle lift 10 is coupled to a truck for moving the vehicle lift 10, the wheel 36 is generally raised.

A trailer hitch 40 is coupled to the front end of the platform 12. The trailer hitch 40 is used for coupling the vehicle lift 10 to a vehicle for towing the vehicle lift 10 to a desired location. Once the vehicle lift 10 is properly aligned with a truck hitch (not shown), the trailer hitch 40 is coupled to the truck hitch of the vehicle in order to tow the vehicle lift 10. Trailer hitches are known to those in the art and will not be described in detail.

In order to prevent the vehicle lift 10 from moving when a vehicle is raised up using the vehicle lift 18, support legs 42 are moveably coupled to each side of the vehicle lift 10. The support legs 42 are lowered prior to lifting a vehicle. The support legs 42 prevent the vehicle lift from toppling/tipping over when a vehicle is raised up using the vehicle lift 18. The support legs 42 are lowered and raised by hydraulics. However, other means may be used such as electric, mechanical, manual, and the like. The listing of the above should not be seen as to limit the scope of the present invention.

A control box 44 is positioned on the platform 12. The control box 44 is used to control movement of the vehicle lift 18, the lift 26 and the support legs 42. The control box 44 will allow one to raise and lower the above mentioned devices. The control box 44 will have means for moving the above elements. Thus, a hydraulic pump, electric motors, mechanical means, or the like will be in the control box 44 to move the above elements.

While the invention has been particularly shown and described with reference to preferred embodiments thereof, it will be understood by those skilled in the art that the foregoing and other changes in form and details may be made therein without departing from the spirit and scope of the invention.

1. A portable mechanics lift comprising:
a platform;
a pair of wheel channels formed on the platform for allowing a vehicle to drive onto the platform;
a vehicle lift coupled to the platform for raising and lowering the vehicle; and
a plurality of wheels rotatably coupled to the platform for moving the portable mechanics lift.

2. A portable mechanics lift in accordance with claim 1 further comprising a plurality of support legs movably coupled to the platform, the support legs being lowered to prevent the vehicle lift from toppling over when the vehicle is raised up using the vehicle lift.

3. A portable mechanics lift in accordance with claim 1 further comprising a swing arm lift rotatably coupled to the platform form lifting and moving heavy objects.

4. A portable mechanics lift in accordance with claim 1 further comprising a front end alignment stand coupled to each wheel channel for analyzing wheel alignment on the vehicle.

5. A portable mechanics lift in accordance with claim 1 further comprising a trailer hitch coupled to a front end of the platform for coupling the portable mechanics lift to a truck to move the portable mechanics lift.

6. A portable mechanics lift in accordance with claim 1 wherein the pair of wheel channels comprises:
“U” shaped channeling coupled to a first side and a second side of the platform, the “U” shaped channeling keeping tires of the vehicle straight; and
a foldable ramp coupled to the “U” shaped channeling, the foldable ramp placed in a lowered position to allow the vehicle to drive up onto the platform, and a raised position to prevent the vehicle from moving on the platform.

7. A portable mechanics lift in accordance with claim 1 wherein the vehicle lift comprises:
a telescoping pole member;
a plurality of arms movably coupled to the telescoping pole; and
a holding device coupled to a distal end of each of the plurality of arms, the holding device securing the arm to the vehicle.

8. A portable mechanics lift in accordance with claim 1 wherein the telescoping pole is raised and lowered by a hydraulic device.

9. A portable mechanics lift in accordance with claim 3 wherein the swing arm lift comprises:
a base pole rotatably coupled to the platform;
an arm coupled to the base pole for raising and lowering objects; and
attachment mechanism coupled to the arm for coupling the objects to the swing arm lift.

10. A portable mechanics lift comprising:
a platform;
a pair of wheel channels formed on the platform for allowing a vehicle to drive onto the platform;
a vehicle lift coupled to the platform for raising and lowering the vehicle;
a plurality of wheels rotatably coupled to the platform for moving the portable mechanics lift;
a plurality of support legs movably coupled to the platform, the support legs being lowered to prevent the vehicle lift from toppling over when the vehicle is raised up using the vehicle lift;
a swing arm lift rotatably coupled to the platform form lifting and moving heavy objects; and
a front end alignment stand coupled to each wheel channel for analyzing wheel alignment on the vehicle.

11. A portable mechanics lift in accordance with claim 10 further comprising a trailer hitch coupled to a front end of the platform for coupling the portable mechanics lift to a truck to move the portable mechanics lift.

12. A portable mechanics lift in accordance with claim 10 wherein the pair of wheel channels comprises:
“U” shaped channeling coupled to a first side and a second side of the platform, the “U” shaped channeling keeping tires of the vehicle straight; and
a foldable ramp coupled to the “U” shaped channeling, the foldable ramp placed in a lowered position to allow the vehicle to drive up onto the platform, and a raised position to prevent the vehicle from moving on the platform.

11. A portable mechanics lift in accordance with claim 10 wherein the vehicle lift comprises:
a telescoping pole member;
a plurality of arms movably coupled to the telescoping pole; and
a holding device coupled to a distal end of each of the plurality of arms, the holding device securing the arm to the vehicle.

12. A portable mechanics lift in accordance with claim 10 wherein the telescoping pole is raised and lowered by a hydraulic device.

13. A portable mechanics lift in accordance with claim 10 wherein the swing arm lift comprises:
a base pole rotatably coupled to the platform;
an arm coupled to the base pole for raising and lowering objects; and
attachment mechanism coupled to the arm for coupling the objects to the swing arm lift.

14. A portable mechanics lift in accordance with claim 13 wherein the swing arm lift further comprises a hydraulic device for controlling the swing arm lift.

15. A portable mechanics lift in accordance with claim 13 wherein the plurality of wheels comprises:
a first pair of wheels rotatably coupled to a first side of the platform;
a second pair of wheels rotatably coupled to a second side of the platform; and
a directional wheel rotatably coupled to a front end of the platform.
